(19) United States
(12) Patent Application Publication
(10) Pub. No.: US 2015/0170107 A1
(43) Pub. Date: Jun. 18, 2015

(54) THROTTLED TASK SCHEDULING BASED UPON OBSERVED TASK VELOCITY

(71) Applicant: SugarCRM Inc., Cupertino, CA (US)

(72) Inventors: Majed Itani, San Jose, CA (US); Dmitriy Kolegayev, West Hollywood, CA (US)

(73) Assignee: SugarCRM Inc., Cupertino, CA (US)

(21) Appl. No.: 14/132,379

(22) Filed: Dec. 18, 2013

(51) Int. Cl. G06Q 10/10; G06Q 10/06

(52) U.S. Cl. CPC G06Q 10/1097; G06Q 10/063114

(57) ABSTRACT

A method for throttled task scheduling based upon the observed task completion velocity of the end user includes measuring a period of time consumed in completing a set of tasks scheduled for an end user for a first time period in a C&S application. A rate of task completion is computed for the end user based upon the measured period of time and the computed rate of task completion applied to a set of tasks scheduled for the end user for a second time period in order to determine whether the set of tasks scheduled for the end user of the second time period cannot be completed by the end user during the second time period. Thereafter, an alert is generated in the C&S application in response to a determination that the set of tasks scheduled for the second time period cannot be completed during the second time period.

### BACKGROUND OF THE INVENTION

1. Field of the Invention

The present invention relates to task management in a calendaring and scheduling (C&S) system and more particularly to individual task scheduling in a C&S system.

2. Description of the Related Art

Tasks are to-dos that are recorded in a C&S system to remind the end user to complete the task at some point in the future. A task list is a list of tasks which are to be completed by the end user and, within a C&S system, may be ordered within a list alphabetically, chronologically in terms of task creation, or in order of assigned priority. In this regard, as tasks can be numerous within a task list, in an effort to assist the end user in determining a particular order in which tasks are to be completed, each task in a task list can be assigned a priority from amongst a range of priorities. In this way, the likelihood of an end user completing an important task can be increased.

The prioritization of only a few tasks in a task list can be a relatively management project, however, as tasks become numerous within a task list, properly assigning a priority to each task can be challenging. In this regard, where an end user manages dozens of tasks, assigning an appropriate priority to a new task relative to existing tasks can be nearly impossible and requires the end user to consider the assigned priority of each existing task in the task list. As and end result, managing a large task list can become a task in unto itself.

Of note, determining how many tasks to schedule on a particular day for an end user can be somewhat of an arbitrary process. Some tasks are not time consuming, while others can consume substantial amounts of time to completion. The degree to which a task can be completed within a period of time depends largely on the speed at which the end user is able to complete tasks. Prioritizing tasks can be helpful, however, because different users will complete the same task of the same priority at different times, prioritization as a general solution cannot present an objective view of when too many or too few tasks are scheduled for an individual on a given day. Rather, the nature of the schedule of an individual is subjective and depends ultimately upon the speed at which the end user completes tasks of the schedule.

### BRIEF SUMMARY OF THE INVENTION

Embodiments of the present invention address deficiencies of the art in respect to task scheduling in a C&S system and provide a novel and non-obvious method, system and computer program product for throttled task scheduling based upon the observed task completion velocity of the end user. In an embodiment of the invention, a method for throttled task scheduling based upon the observed task completion velocity of the end user is provided. The method includes measuring a rate of completion of a set of tasks scheduled for an end user for a first time period in a C&S application. The method also includes applying the measured rate of task completion to a set of tasks scheduled for the end user for a second time period in the C&S application in order to determine whether or not the set of tasks scheduled for the end user of the second time period cannot be completed by the end user during the second time period. Thereafter, an alert is generated in a user interface of the C&S application in response to a determination that the set of tasks scheduled for the end user of the second time period cannot be completed by the end user during the second time period.

In one aspect of the embodiment, the end user can be prompted in the user interface to schedule additional tasks for the second time period in response to a determination that the set of tasks scheduled for the end user of the second time period can be completed by the end user during the second time period with a threshold period of time remaining available and unconsumed for the second time period. In another aspect of the embodiment, a separate rate of task completion is computed for each grouping of tasks of a common task type in the set of tasks scheduled for an end user for a first time period, each separate rate of task completion is applied to a corresponding grouping of tasks of a common task type in the set of tasks scheduled for the end user for the second time period to produce separate expected times to complete the grouping of tasks of each common task type, and the expected times to complete all groupings of tasks for all common task types are summed to determine whether or not the set of tasks scheduled for the end user of the second time period cannot be completed by the end user during the second time period.

In another embodiment of the invention, a C&S system is provided. The system includes a host computing system with at least one host computer with memory and at least one processor and a C&S application executing in the memory of the host computing system. A data store of tasks is coupled to the C&S application, each of the tasks corresponding to a particular end user of the C&S application and scheduled for a particular day. Finally, the system includes a throttled task scheduling module coupled to the C&S application. The module includes program code that when executed in the memory of the host computing system is enabled to measure a rate of completion of a set of the tasks in the data store that are scheduled for a particular end user for a first time period, to apply the measured rate of task completion to a different set of tasks in the data store that are scheduled for the end user for a second time period in order to determine whether or not the different set of tasks scheduled for the particular end user of the second time period cannot be completed by the particular end user during the second time period, and to generate an alert in a user interface of the C&S application in response to a determination that the different set of tasks scheduled for the particular end user of the second time period cannot be completed by the particular end user during the second time period.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for throttled task scheduling based upon the observed task completion velocity of the end user;

FIG. 2 is a schematic illustration of a C&S data processing system configured for throttled task scheduling based upon the observed task completion velocity of the end user; and,

FIG. 3 is a flow chart illustrating a process for throttled task scheduling based upon the observed task completion velocity of the end user.

### DETAILED DESCRIPTION OF THE INVENTION

Embodiments of the invention provide for throttled task scheduling based upon the observed task completion velocity of the end user. In accordance with an embodiment of the invention, the rate at which an end user completes tasks in a task list can be observed and recorded. The rate can be observed for all tasks, tasks of a particular priority and tasks of a particular type, such as a task for composing an e-mail, a task for adding a contact, a task for posting a comment to social media, a task for composing a document, or a task for placing a phone call, to name only a few exemplary tasks. Thereafter, the task list for the end user can be analyzed in accordance with the observed rate and compared to an amount of time available to complete tasks for a given range of time such as a day. Consequently, a determination can be made whether or not the end user is able to complete all tasks scheduled for the range of time, and if so, whether additional tasks can be scheduled for the range of time without exceeding the available amount of time.

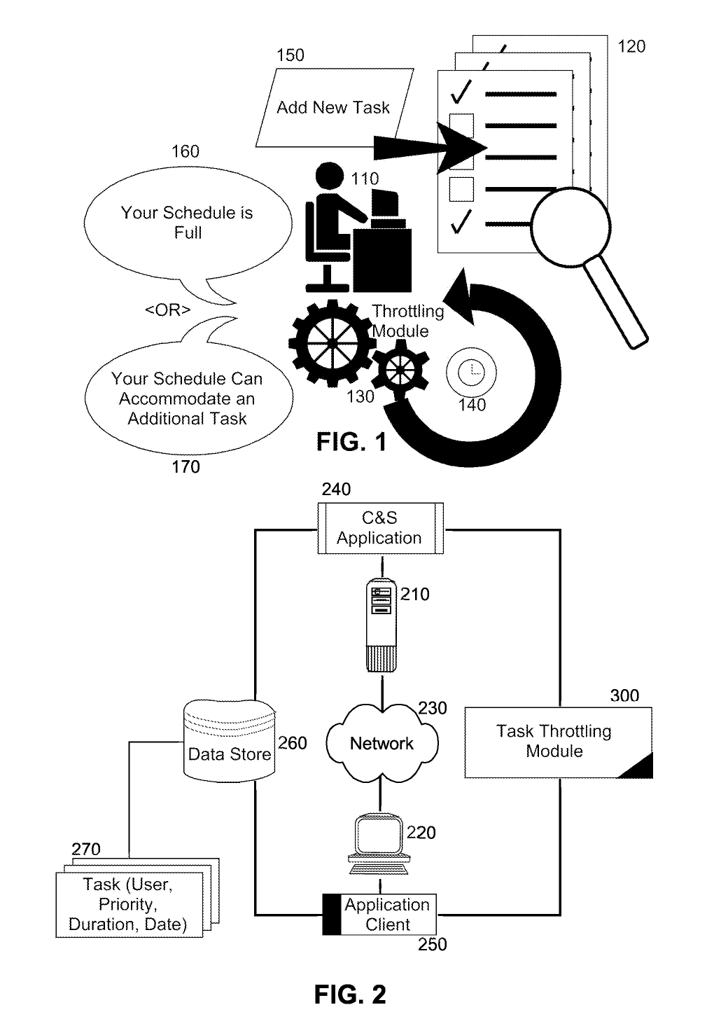

In illustration, FIG. 1 pictorially shows a process for throttled task scheduling based upon the observed task completion velocity of the end user. As shown in FIG. 1, an end user 110 can schedule different tasks in different task lists 120 for different days. Throttling module 130 can monitor the rate of completion 140 by the end user 110 of the different tasks of the different task lists 120. Thereafter, the throttling module 130 can apply the rate of completion 140 to the tasks of a contemporaneous or future one of the task lists 120 for a particular range of time to determine whether or not the tasks of the contemporaneous or future one of the task lists 120 can be completed within the particular range of time. If not, an alert 160 can be generated. Otherwise, the throttling module 130 can prompt the end user 110 with prompt 170 to add an additional task 150 to the tasks of the contemporaneous or future one of the task lists 120.

The process described in connection with FIG. 1 can be implemented within a C&S data processing system. In further illustration, FIG. 2 schematically shows a C&S data processing system configured for throttled task scheduling based upon the observed task completion velocity of the end user. The system can include a server computing system 210 that includes one or more computers, each with at least one processor and memory and supporting the operation of a C&S application 240. The server computing system 210 can be coupled over computer communications network 230 to a client computer 220 with at least one processor and memory and supporting the operation of an application client 250 accessing the C&S application 240.

The C&S application 240 and the application client 250 can access a data store 260 disposed in either or both of the server computing system 210 and the client computer 220. The data store 260 can include a set of tasks 270. Each of the tasks 270 can be associated with a particular end user, an assigned priority, and a date upon which the task is to be completed. Of note, task throttling module 300 can be coupled to either or both of the C&S application 240 and the application client 250. The task throttling module 300 can include program code that when executed in the memory of the server computing system 210 or the client computer 220 is enabled to determine a rate of completion of tasks 270 in the data store 260 for different end users, for example an average rate of completion. Optionally, program code of the task throttling module 300 can determine a rate of completion of the tasks 270 for ones of the tasks 270 of a common priority or common task type, for example tasks relating to phone calls as one type, tasks relating to e-mail messages as another type, tasks relating to the drafting of documents as yet another type and so forth.

Utilizing the computed rate of completion of the tasks 270, the program code of the task throttling module 300 can process a selection of the tasks 270 for an end user for a specified range of time in order to determine whether or not the selection of the tasks 270 are likely to be completed within the specified range of time. If not, the program code of the task throttling module 300 can direct an alert to be presented in the application client 240 that the range of time has been overloaded with too many tasks given the observed velocity of task completion of the end user. Otherwise, if the program code of the task throttling module 300 determines that the selection of the tasks 270 for the specified range of time can be completed amply within the specified range of time, the program code can direct a prompting in the application client 240 for the end user to add one or more additional tasks for the specified range of time.

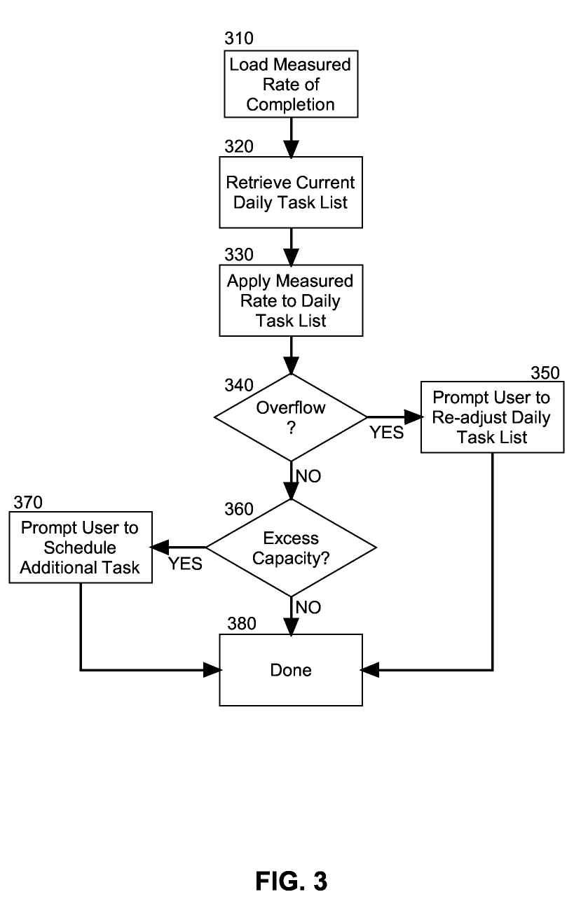

In even yet further illustration of the operation of the throttling module 300, FIG. 3 is a flow chart illustrating a process for throttled task scheduling based upon the observed task completion velocity of the end user. The process can begin in block 310 with the loading of a pre-observed rate of completion for one or more tasks for a particular end user. In block 320, a current daily task list can be retrieved for the end user for a particular day—contemporaneous or in the future—that includes those tasks scheduled for completion for a that day. In block 330, an estimated time of completion can be computed for the tasks of the list based upon the pre-observed rate of completion. Optionally, different rates of completion can be loaded for different task types or task priorities and applied only to corresponding tasks of the same type or priority, with the resulting estimated time to complete all tasks in the list being determined based upon a sum of the estimated times to complete the tasks of different types or priorities.

In decision block 340, it can be determined whether or not an overload condition exists for the list based upon the estimated time to complete all tasks in the list. If so, in block 350 the end user can be alerted to the overload condition and one or more tasks in the list can be suggested for re-scheduling. In this regard, the task estimated to consume the most time to complete can be suggested for rescheduling, a lowest priority task in the list can be suggested for rescheduling or a task in the list of a particular type can be suggested for rescheduling. Further, enough tasks of the same priority and type can be suggested for rescheduling so as to remove the overload condition of the list. In any event, the process can end in block 380.

In decision block 340, if it is determined that an overload condition does not exist for the list, in decision block 360 it can be additionally determined if additional capacity to schedule one or more tasks exists for the list based upon the estimated time to complete all tasks in the list. If so, in block 370 the end user can be prompted to schedule one or more additional tasks into the list. In this regard, the additional tasks can be selected from lists for other days, or the end user can be prompted to schedule new tasks of specific priorities or types such that the scheduling of the new tasks does not create an overload condition for the list. Thereafter, the process can end in block 380.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for throttled task scheduling based upon the observed task completion velocity of the end user, the method comprising:
measuring a rate of completion of a set of tasks scheduled for an end user for a first time period in a calendaring and scheduling (C&S) application executing in memory of a computing system;
applying the measured rate of completion to a set of tasks scheduled for the end user for a second time period in the C&S application in order to determine whether or not the set of tasks scheduled for the end user of the second time period cannot be completed by the end user during the second time period; and,
generating an alert in a user interface of the C&S application in response to a determination that the set of tasks scheduled for the end user of the second time period cannot be completed by the end user during the second time period.

2. The method of claim 1, further comprising prompting the end user in the user interface to schedule additional tasks for the second time period in response to a determination that the set of tasks scheduled for the end user of the second time period can be completed by the end user during the second time period with a threshold period of time remaining available and unconsumed for the second time period.

3. The method of claim 1, wherein the set of tasks are tasks of a common priority.

4. The method of claim 1, wherein the set of tasks are tasks of a common task type.

5. The method of claim 1, wherein:
a separate rate of task completion is computed for each grouping of tasks of a common task type in the set of tasks scheduled for an end user for a first time period,
each separate rate of task completion is applied to a corresponding grouping of tasks of a common task type in the set of tasks scheduled for the end user for the second time period to produce separate expected times to complete the grouping of tasks of each common task type; and,
the expected times to complete all groupings of tasks for all common task types are summed to determine whether or not the set of tasks scheduled for the end user of the second time period cannot be completed by the end user during the second time period.

6. A calendaring and scheduling (C&S) system comprising:
a host computing system comprising at least one host computer with memory and at least one processor;
a C&S application executing in the memory of the host computing system;
a data store of tasks coupled to the C&S application, each of the tasks corresponding to a particular end user of the C&S application and scheduled for a particular day; and,
a throttled task scheduling module coupled to the C&S application, the module comprising program code that when executed in the memory of the host computing system is enabled to measure a rate of completion of a set of the tasks in the data store that are scheduled for a particular end user for a first time period, to apply the measured rate of task completion to a different set of tasks in the data store that are scheduled for the end user for a second time period in order to determine whether or not the different set of tasks scheduled for the particular end user of the second time period cannot be completed by the particular end user during the second time period, and to generate an alert in a user interface of the C&S application in response to a determination that the different set of tasks scheduled for the particular end user of the second time period cannot be completed by the particular end user during the second time period.

7. The system of claim 6, wherein the program code of the module is further enabled to prompt the particular end user in the user interface to schedule additional tasks for the second time period in response to a determination that the different set of tasks scheduled for the particular end user of the second time period can be completed by the particular end user during the second time period with a threshold period of time remaining available and unconsumed for the second time period.

8. The system of claim 6, wherein the tasks in the data store are tasks of a common priority.

9. The system of claim 6, wherein the wherein the tasks in the data store are tasks of a common task type.

10. The system of claim 6, wherein:
a separate rate of task completion is computed for each grouping of tasks of a common task type in the set of tasks scheduled for an end user for a first time period,
each separate rate of task completion is applied to a corresponding grouping of tasks of a common task type in the set of tasks scheduled for the end user for the second time period to produce separate expected times to complete the grouping of tasks of each common task type; and,
the expected times to complete all groupings of tasks for all common task types are summed to determine whether or not the set of tasks scheduled for the end user of the second time period cannot be completed by the end user during the second time period.

11. A computer program product for throttled task scheduling based upon the observed task completion velocity of the end user, the computer program product comprising:
a computer readable storage medium having computer readable program code embodied therewith, the computer readable program code comprising:
computer readable program code for measuring a rate of completion of a set of tasks scheduled for an end user for a first time period in a calendaring and scheduling (C&S) application executing in memory of a computing system;
computer readable program code for applying the measured rate of task completion to a set of tasks scheduled for the end user for a second time period in the C&S application in order to determine whether or not the set of tasks scheduled for the end user of the second time period cannot be completed by the end user during the second time period; and,
computer readable program code for generating an alert in a user interface of the C&S application in response to a determination that the set of tasks scheduled for the end user of the second time period cannot be completed by the end user during the second time period.

12. The computer program product of claim 11, further comprising computer readable program code for prompting the end user in the user interface to schedule additional tasks for the second time period in response to a determination that the set of tasks scheduled for the end user of the second time period can be completed by the end user during the second time period with a threshold period of time remaining available and unconsumed for the second time period.

13. The computer program product of claim 11, wherein the set of tasks are tasks of a common priority.

14. The computer program product of claim 11, wherein the set of tasks are tasks of a common task type.

15. The computer program product of claim 11, wherein:
a separate rate of task completion is computed for each grouping of tasks of a common task type in the set of tasks scheduled for an end user for a first time period,
each separate rate of task completion is applied to a corresponding grouping of tasks of a common task type in the set of tasks scheduled for the end user for the second time period to produce separate expected times to complete the grouping of tasks of each common task type; and,
the expected times to complete all groupings of tasks for all common task types are summed to determine whether or not the set of tasks scheduled for the end user of the second time period cannot be completed by the end user during the second time period.

16. A task scheduling method comprising:
tracking a rate of task completion for tasks scheduled for completion by an end user;
loading into memory of a computer a list of tasks scheduled for a particular time range for the end user;
determining whether or not the end user is likely to complete the tasks in the list during the particular time range based upon the rate of task completion; and,
generating an alert condition if it is determined that the end user is not likely to complete the tasks in the list during the particular time range based upon the average rate of task completion, but suggesting scheduling at least one additional task during the particular time range if it is determined that the end user is likely to complete the tasks in the list during the particular time range based upon the rate of task completion.
